(19) United States
(12) Patent Application Publication
(10) Pub. No.: US 2019/0162514 A1
(43) Pub. Date: May 30, 2019

(54) MARKING TAPE FOR FRAMING LAYOUT

(71) Applicant: David L. LeMieux, Clancy, MT (US)

(72) Inventor: David L. LeMieux, Clancy, MT (US)

(21) Appl. No.: 15/828,004

(22) Filed: Nov. 30, 2017

(51) Int. Cl. G01B 3/10; E04G 21/18; B25H 7/04

(52) U.S. Cl. CPC G01B 3/1084; E04G 21/1891; G01B 2003/1043; G01B 2003/1094; G01B 2003/1089; B25H 7/04

(57) ABSTRACT

A roll of marking tape for framing layout is marked with a plurality repeating series of “on-center” marks for common stud, joist or rafter at distances, such as 12, 16 and 24 inch locations. The builder appropriately positions the tape relative to a reference point such as an end-edge of a plate, then attaches the tape to the plate. An alternate embodiment comprises a computer, software and a printer to allow a builder to enter building plans into a computer and print customized tape that has marks matching job plans. In another alternate embodiment a portable plate marker system prints marks onto a plate (without using tape). In another alternate embodiment a wheel marking system prints marks onto a plate (also without using tape).

### BACKGROUND OF THE INVENTION

The framing of buildings is a well-known trade and many standard conventions apply to the spacing of framing members (studs) when they are attached to plates, for example, ceiling (top) and floor (bottom) plates. The most common spacing are on 12, 16 and 24 inch centers. To teach conventional steps for framing studs on a 16 inch on-center wall, a video is provided on the World Wide Web at: https://www.youtube.com/watch?v=2VwXv3x_5k8. This teaching requires the builder to:
1. lay both the top and bottom plates adjacent together with their end-edges being flush;
2. from the end-edge of the plate, measure with a steel layout measure tape to mark a first stud location line at 15¼ inches and to mark subsequent lines from the end-edge at ¾ inch less than each subsequently measured 16 inch interval distance along the length of plate (this accommodates standard dimensional lumber members having a nominal width of 1½ inches and places the center of stud members on 16 inch centers).
3. Using a framing square the builder then draws at least one line over each marked line and across both plates, to better show the attachment location of a member to the plate.

Since plates are long slender boards of wood or steel, they are typically placed on the floor so the marking process usually requires the builder to work from a kneeling position which is slow and causes fatigue. Builder drawn marks are often difficult to see, often confusing to read, and sometimes get rubbed off or otherwise removed before they can be used. Also to accommodate door or window openings the builder must measure and mark the openings and mark specialized studs like king, jack and cripple studs to accommodate the openings. To avoid errors that lead to rework, the process of conventional marking requires a skilled builder that is good with math including fractions.

Regarding background art there are various measurement and plate marking tools to aid framing layout. As an example, in U.S. Pat. No. 6,775,916 Sparkes characterizes a Framer's Layout Square for marking positions of stud locations on a plate. In another example, in Patent No. EP1642663A1, Koskovich provides a method that includes a step of applying indicia on at least a selected print location on each of the boards by a marking station.

While Sparkes offers improvements to the art, all of the problems described above still remain. Further the Sparkes tool does not provide the simplicity, manufactured control or speed of affixing marks to plates as described in the presently disclosed framing or marking tape, plate marking or wheel marking systems. Next, although the Koskovich apparatus achieves the same outcome of marking plates as the invented customized marking tape and the invented plate marking system, a key difference to the invented plate marking system, is that the invented plate marking system is easily portable to a job site and marks while passing across a fixed or stationary plate. Koskovich requires a computer controlled system to convey and position a plate in a desired location relative to a print head which means that Koskovich's apparatus is not portable and therefore not suitable for use on a job site. Those skilled in the art will however recognize that the algorithms used by the invented plate marking system uses a same or similar approach as Koskovich for collecting builder plan data and determining desired mark locations on a plate since the approach is a standardized process that has been used in many countries for more than 30 years.

None of the references teach or suggest the invention disclosed herein. What is needed is a marking tape or in alternate embodiments, plate marking or wheel marking systems, that overcomes the disadvantages of the background art. To address the disadvantages of the background art, a marking tape, a system for printing customized marking tape that produces a customized marking tape, plate marking system, and a wheel marking system is disclosed herein.

### BRIEF SUMMARY OF THE INVENTION

The purpose of the invention is to provide means and methods for indicating the attachment location of stud members to plates when framing buildings.

The present invention relates to a spool, roll or length of marking tape for use in construction when framing a building. The marking tape contains a plurality of marks indicating where framing members (such as studs, joists or rafters) are to be attached to a plate. More specifically the main embodiment of this invention relates to a marking tape that contains a plurality of marks in a repeating series with marks being substantially representative of common layout “on-center” distances, such as common 12, 16 and 24 inch on-center marks. In an alternate embodiment tape printing system allows a builder to input construction plans into a software program to print the marks on the tape. For this alternate embodiment, the tape comprises printed marks that match job specific layout plans and may also contain customized marks to accommodate job specific openings for windows or doors and may also include other job specific information. Printed tape is attached to plates to indicate member attachment locations. In yet another alternate embodiment a plate marking system prints marks at desired member attachment locations on a plate (without using a pre-marked tape). In yet another alternate embodiment a wheel marking system prints marks at desired member attachment locations on a plate (also without using a pre-marked tape).

In contrast to conventional methods, in an embodiment of the present disclosure, a builder attaches a pre-marked marking tape consisting of a plurality of repeating or concatenated series or groups of marks to a plate. As an example, to mark 16 inch on-center locations, the builder in application aligns the middle of a mark representing a 16 inch on-center mark or otherwise substantially indexes or positions any one of the 16 inch on-center marks on a plate and then affixes the tape to the plate using a staple hammer or alternately using adhesive affixed to on the bottom (second) side of the tape. Next in application, the builder unrolls the tape along the length of the plate, further securing the tape in place by affixment to the plate with more staples. These tape marks represent any one of common stud, truss or rafter (member) locations and constitute the vast majority of the plate marks required on a job. However, since the tape may only include common on-center mark distances, such as 12, 16 or 24 inches, the builder finishes the layout by using a conventional steel measuring layout tape and at least one tape mark reference location (that has been previously affixed to the plate) or the end-edge reference location of plate, to measure and mark specialized stud locations, for example, for window or door openings.

Also in contrast to conventional methods, in an alternate embodiment the builder uses a tape having custom pre-printed marks that match layout or framing plans. This customized tape includes both marks for desired standard on-center locations and marks for specialized stud locations to accommodate for openings, for example, for windows or doors. This alternate embodiment is described in more detail later.

Those skilled in the art will recognize by convention that some countries have different dimensional standards for lumber. Therefore although the North America standards may be different in other countries, the other countries use a parallel approach even though their actual dimensional standards may be different. For example in Norway, a “two-by-four” is nominally 98 millimeters wide (3.86 inches) and studs, joists and rafters are spaced at on-center distances of 60 centimeters (23.62 inches). This allows framing in Norway to accommodate their plywood sheets which are in multiples of 60 centimeters in both X-Y directions. For purposes of clarity this patent will focus on the North American standards. However given this teaching by definition any change in a dimensional standard of lumber does not limit this invention, regardless of a stated on-center distance or mark width. Further given this teaching, by definition if patent language discusses an on-center measurement of 16 inches this shall be interpreted as also meaning 12 inches or 24 inches or any combination of these, without limitation.

To avoid confusion additional definitions include:
A “member” or “construction member” is defined as any type of stud, joist, truss or rafter and more generally includes a plurality of members that form the structure of a floor, wall or roof and are attached to a plate. Studs are knows by names as common, king, jack and cripple.
A “plate” is defined as a slender board often referred to as a ceiling or top or header and as a floor or bottom or sole board. The layout marks are located on the plates to indicate the attachment locations of construction members (such as studs, joists, and trusses) to the plates. A plate more generally means any board that normally receives layout marks to show attachment locations of one or more construction member.
“On-center” or “center” means a spacing distance between the midline or centers of a plurality of members and in practice commonly results in most members being equally spaced on plates.
“Specialized studs” means any one of king, jack or cripple studs; these are members commonly used to frame window or door openings.
An “end-edge” is a measuring reference location on a plate formed by the cut end of a slender plate board and for purposes of this invention is used as the reference point to measure from to layout the marks on a plate.
A “mark” preferably consists of a graphical pattern that matches the cut-end of dimensional lumber e.g. a pattern being 3½ by 1½ inches; however a “mark” can be any visual indicator to instruct a builder in the placement for affixment of a member to a plate.
“Index” means to position any one of a tape mark, a plate marker system a wheel marking system, and a metal measuring tape with the end-edge of a plate such that subsequent plurality of desired marks will be located and substantially desired locations on a plate.
Tape markings may be represented as a series and those skilled in the art will recognize that each series is repeated or in other words each series of marks may be in a group and the groups repeated as though concatenated on the tape (this will be graphically demonstrated later). Although not limiting, for North America a “series” may be comprised of:
   a “first series” of uniformly spaced marks, each mark substantially representative of a 12 inch on-center location; or
   a “second series” of uniformly spaced marks, each mark substantially representative of a 16 inch on-center location; or
   a “third series” of uniformly spaced marks, each mark substantially representative of a 24 inch on-center location; or
   a “fourth series” of marks is substantially representative of any combination of marks in said first, second or third series; or
   a “fifth series” of marks is substantially representative of at least one of 12, 16 or 24 inch on-center locations; or
   a “sixth series” of marks is substantially representative of any desired grouping of marks indicating at least one desired attachment location of a member to a plate.
   a “seventh series” of marks includes a sixth series of marks and also includes customized marks intended to indication member locations for openings such as windows and doors (art practitioners will recognized that the inclusion of customized marks means that a seventh series is technically not being a repeating series since the customized marks also accommodate for openings; however it is used here to maintain a series numbering convention).
Tape markings for Norway may consist of:
   an “eight series” of uniformly spaced marks, each mark substantially representative of a 60 centimeters (23.62 inches) on-center location.

The layout marking tape provided through teachings of this invention avoids many of the prior art problems and offers a highly portable, less error prone, and a faster means to mark plates for expedited construction work. Given this teaching, those skilled in the art will recognize the other embodiment teachings as alternative improved ways to mark plates.

One object of the invention is to provide marking tape having a series of marks with common on-center distances including 12, 16 and 24 inches. Although any mark is possible, a conventional mark for North American dimensional lumber preferably represents lines spaced 1½ inches wide and having an “X” between line the lines. Alternately the tape may have a 12, 16 and/or 24 number to numerically indicate the on-center location of the mark. The tape can be attached to the plate with a plurality of staples or alternately using adhesive on the bottom (second) side of the tape. It is to be understood that marking tape can be produced to show any one of or any combination of 12, 16 and 24 inch on-center spacing or other spacing distances. Further those skilled in the art will recognize that 24 is a multiple of 12 and that 48 is a multiple of 12, 16 and 24; therefore a universal tape displaying all three common on-center distances (12, 16 and 24 inches) will be a fifth series consisting: of unique marks to indicate 12 and 16 inch on-center locations; a mark to indicate the multiple coincidence of a 12 and 24 inch on-center location; and two marks to indicate the multiple coincident of 12, 16 and 24 inch on-center locations. Together these from a family or group of marks. These mark locations are graphically presented later. In use the marking tape is indexed on the plate and then affixed to the plate.

In an alternate embodiment, it is another object of the invention to provide a builder with a modified steel measuring tape with above described marks displayed on the tape, from the measure tape hooked tab end. When measuring, the hooked tab end couples to an end-edge of a plate.

In an alternate embodiment, it is another object of the invention for the builder to print marks on the marking tape to produce job specific customized tape that has marks that substantially match construction building plans. This alternate embodiment employs a computer, a software, a printer, and a roll or length of tape. In use the builder enters framing construction data or building plans into a computer software system and prints customized tape that has marks that substantially match job plans. In other words, the software receives and stores builder input data according to desired building plans and then determines media content to be printed onto the tape. Then the software drives or controls the printer to print a plurality of marks on the tape, with each mark being located at a substantially desired location representative of a member attachment location on a plate.

Another object of the invention is tape printing system for the builder to enter building plans into a computer software system and to print customized tape that has marks that match job plans. This alternate embodiment is comprised of a computer, software and a printer. The software interprets job plan information, determines and prints a plurality of desired mark locations on the tape. The advantage to this alternate embodiment is that the printed tape marks also include the customized member locations for window or door openings. The custom tape also preferably includes information that instructs the builder where the tape is to be installed on the project (example information may include a name or description of the wall that the tape will be used for constructing and the starting end-edge of the plate end to unroll the tape). Like the preferred embodiment the printed customized marking tape (with opening member locations) is installed by first indexing the tape to a plate end-edge and then attaching the tape to the plate. In another alternate embodiment of the invention, it's an object of the invention for the builder to use a plate marker system to print marks directly onto the plate (without using tape). In this alternate embodiment a marking system comprised of a handle, a wheel having a known circumference and a start indicator line located on the body or frame, a wheel travel sensor, a control subsystem and a marking subsystem.

The wheel travel sensor of the plate marker system can be any sensor technology that senses wheel travel. While not limiting, possible travel sensors include, but are not limited to, an encoder sensing wheel hub angular position, rotation, or travel, an optical detector attached to the frame and focused on reflective targets affixed to the rotating wheel to send a trigger signal to the sub-control system when the wheel has traveled a specified distance, a digital inclinometer attached to the wheel to measure wheel position, orientation or travel direction, a micro switch attached to the frame and actuated by flags that rotate with the wheel. Other sensors are possible without limit.

The marking subsystem of the plate marker system may be any marking technology suitable for making a mark on a plate. While not limiting, possible marking subsystems include a load source operated spray paint such as an aerosol paint can or chalk or other marking media, a laser, an ink soaked stamp, an ink jet, a snap chalk line. Other marking equipment is possible without limit.

The control subsystem of the plate marker system is comprised of a power supply such as a battery, at least one voltage regulator, a microcontroller, a start button and appropriate GUI and control equipment determined by those skilled in the art.

The plate marking system may be in a first or a second form. In operation of a first form of the plate marker system; the builder places the wheel on the plate, aligns the start indicator line with the plate end-edge, then using the control subsystem selects a desired on-center marking distance and presses a start button. Next the builder rolls the wheel down the plate and the control subsystem continuously receives a first signal from a travel sensor and determines a measured travel distance from the plate end-edge. When a travel distance substantially matches a desired on-center marking distance the control subsystem operates the marking subsystem to print a mark on the plate. As the wheel rolls down the plate a plurality of marks are printed on the plate with each mark being substantially representative of a desired on-center marking distance for a member attachment location.

In operation a second form of the plate marker system includes a control subsystem having a Graphical User Interface (GUI) and specialized firmware. In operation the builder first uses the GUI to enter plan information into the control subsystem which then determines desired mark locations for member attachment, including window and door opening information. Next the builder indexes the plate marking system by aligning a start indicator line, located on the plate marker system frame, with the plate end-edge and presses a control subsystem start button to commence measuring. Next the builder rolls the wheel down the plate and the control subsystem continuously receives a first signal from a travel sensor to determine a measured travel distance from the plate end-edge. Since the control subsystem also determines desired mark locations from the plan information, when a travel distance substantially matches a desired on-center or specialized stud marking distance the control subsystem operates the marking subsystem to print a mark on the plate. As the plate marker system progresses along the plate the builder ensures the rolling wheel remains in contact with the plate and the plate marker system prints or otherwise applies a plurality of marks on the plate with each mark being substantially representative of a desired member attachment location to the plate.

In another embodiment of the disclosure, it's an object of the invention for the builder to use a wheel marking system to print marks onto the plate (without using tape). This alternate embodiment is comprised of a handle coupled to a wheel hub, a wheel having a pocket in the wheel (in the rolling surface where the wheel contacts a plate) and an ink pad located in the pocket. Preferably the ink pad protrudes from the pocket but compresses into the pocket when transferring ink to a plate. To produce 16 inch on-center marks, the wheel has a circumference of 16 inches and the ink pad produces marks to match dimensional board thickness of 1½ inches. As the wheel is rolled along a plate, for each wheel rotation ink is transferred from the ink pad to place a mark on the plate. In operation of the wheel marking system, the builder selects a wheel of a desired circumference dimension e.g. select a 16 inch circumference wheel to make 16 inch on-center marks; then collinearly aligns a plate end-edge with wheel start indicator line (coinciding with the middle of the ink pad), then rolls the wheel along the plate and the ink pad transfers ink to the plate to make plate marks at substantially desired center locations. Optionally an ink well or container of marking fluid dispenses ink to the ink pad through an ink transport tube by gravity upon each wheel rotation. Other marking dispensers are possible without limit.

Further aspects of the invention will become apparent from consideration of the drawings and the ensuing description of preferred embodiments of the invention. A person skilled in the art will realize that other embodiments of the invention are possible and that the details of the invention can be modified in a number of respects, all without departing from the disclosed concepts. Thus, the following drawings and description are to be regarded as illustrative in nature and not restrictive.

### BRIEF DESCRIPTION OF THE DRAWINGS

The features of the invention will be better understood by reference to the accompanying drawings which illustrate presently preferred embodiments of the invention. In the drawings:

FIG. 1 presents an elevation view of fifth series marks on tape to accommodate any of 12, 16 and 24 inch on-center construction;

FIG. 2 is a line drawing that shows a plate marker system; and

FIG. 3 is an isometric view of a wheel marking system.

The following reference numerals are used to indicate the parts and environment of the invention on the drawings:
2 tape with marks, pre-marked tape, marking tape
4 tape
6 first mark, indicative of 12 inch on-center location
8 second mark, indicative of 16 inch on-center location
12 fourth mark, indicative of coincident 12 and 24 inch on-center location
14 fifth mark, indicative of coincident 12, 16, and 24 inch on-center location
16 series, repeating series of marks, group, concatenation of series or groups
18 mark center-line indicator, index marker, index line
20 plate marker system
22 handle
24 frame
26 wheel having a known circumference, wheel
28 frame start indicator line, index line
30 control subsystem
32 a wheel travel sensor, encoder
36 solenoid actuator, solenoid
38 linkage 40 aerosol can of marking paint
42 frame marking hole, through hole forming a shroud
44 distance between frame start indicator line and the contact point of wheel to plate
50 wheel marking system, wheel marking
52 handle
54 axel, bearing, hub, wheel hub
56 wheel
58 wheel rolling contact surface, wheel contact plate surface
60 ink pad
62 wheel circumference dimension
64 ink pad marking dimension, ink pad rolling marking dimension
66 wheel thickness dimension, wheel width dimension
68 ink well, ink vessel, container of marking fluid
70 ink transport tube, conduit hose
72 wheel start indicator line, start indicator line, index line

### DETAILED DESCRIPTION OF THE INVENTION

The following description of the disclosed embodiments of the invention is merely exemplary in nature and is in no way intended to limit the invention, its application, or uses.

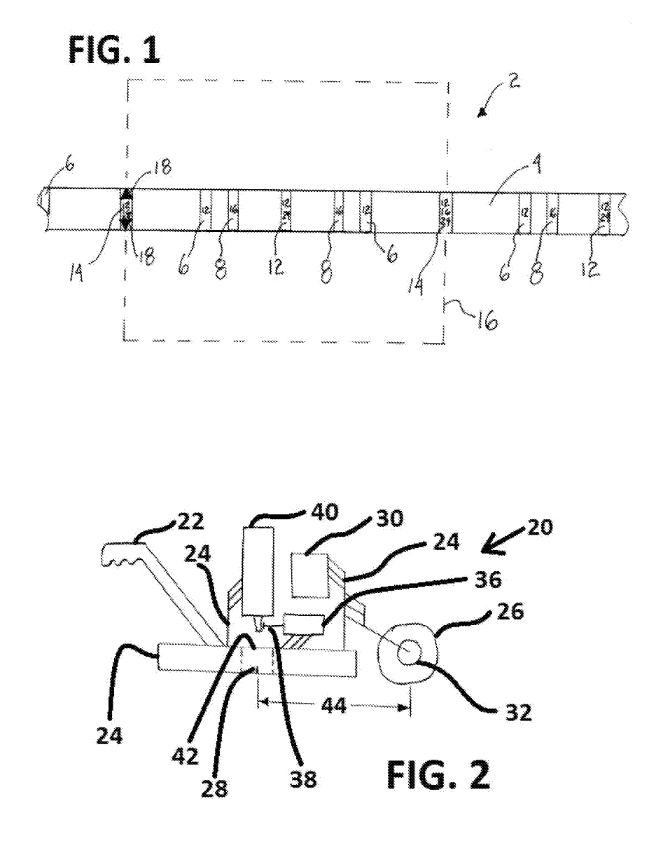

Referring to FIG. 1 an elevation view of pre-marked tape 2 is presented. Tape 4 includes a plurality of marks shown as follows:
A first mark 6 substantially represents a 12 inch on-center location (actually a two mark set for the sides of the stud member);
A second mark 8 substantially represents a 16 inch on-center location (actually a two mark set for the sides of the stud member);
A fourth mark 12 substantially represents a 12 or 24 inch on-center location (actually a two mark set for the sides of the stud member); and
A fifth mark 14 substantially represents a 12, 16 or 24 inch on-center location (actually a two mark set for the sides of the stud member).
   Those skilled in the art will recognize, in detail that the above described marks collectively form series group 16 of marks, having a first boundary through center-line indicator 18 mark and a second boundary through the next center-line mark of the coincident multiple mark indicated as 12, 16 and 24 inch. This fifth series, group 16 is repeated as though perpetually concatenated on the length of tape, however repetition is not shown in FIG. 1 for purposes of clarity and due to limitations of page size.

Now looking in more detail, any mark may optionally have at least one mark center-line indicator 18 to aid the builder when collinearly positioning a tape mark with the end-edge of a plate (when appropriately positioning or indexing the marking tape on a plate). For purposes of clarity only one of fifth mark 14 has a center-line indicator 18 shown in FIG. 1 but every mark may have a center-line indicator 18.

Given the illustration of FIG. 1, it is understood in yet another alternate embodiment that to avoid builder confusion the tape may contain marks on both the top (first) and bottom (second) sides of tape 4 to allow the builder to attach tape 4 to a plate with either first or second side up depending on their construction goals. Although not limiting, to illustrate and to further teach this concept, those skilled in the art may now to conceptualize tape 4 having the following alternate markings to those shown in FIG. 1. For example, a first side of tape marked with a repeating series of second mark 8 indicating a 16 inch on-center location; and a second side of tape marked with a repeating series plurality of third mark (not shown) indicating a 24 inch on-center location.

Still referring to FIG. 1, in use to index the marking tape 4 the builder selects a desired mark according to their layout objective and collinearly aligns the center of the selected mark with the end-edge of a plate, preferably with the aid of at least one tape 4 center-line indicator 18; then affixes tape 4 to the plate, and unrolls tape 4 along the length of the plate while further affixing tape 4 to plate where necessary to secure tape 4 to the plate. The graphic for each mark shown in FIG. 1 provides two lines for the builder to collinearly align the sides of members to and center-line indicator 18 (also preferably included in the graphic for each mark) is used to collinearly align with the end-edge of the plate. For an example of use, to display marks for a desired 16 inch on-center wall, a builder first preferably selects a mark with a “16” printed on it and located nearest the end of the tape roll (these are any of second mark 8 or fifth mark 14). Next the builder indexes the tape by collinearly aligning the mark center-line indicators 18 of the selected mark with the end-edge of the plate and affixes the tape to the plate. Then, the builder unrolls the tape along the plate, further affixing the tape to the plate as needed. When the members are affixed to the plate, the center of each member will collinearly align with the graphical center-line indicator 18 of the desired mark, representative of layout plans, and sides of each member will collinearly align with the illustrated graphical lines portraying the boundaries of each mark.

Referring to FIG. 2, a line drawing of an example plate marker system 20 is shown. The system is comprised of a handle 22, affixed to a frame 24 that slides at a first end on a plate (not shown) and rides at a second end on a wheel 26, with frame 24 having a frame start indicator line 28. The system is further comprised of a control subsystem 30 that includes a power supply, at least one voltage regulator, microprocessor, solenoid driver, and a start indicator switch. The system is further comprised of an encoder 32 that senses wheel rotation. Marking subsystem is comprised of a solenoid actuator 36 having a linkage 38 which is mechanically coupled and configured to actuate a spray nozzle and thereby operate an aerosol can 40 of marking paint to produce a mark on a plate. Finally a though hole shroud 42 in frame 24 confines over-spray of marking paint from can 40 to produce desired member visual mark. Although not shown for simplicity, encoder 32 and solenoid 36 are appropriately wired to control subsystem 30. Still referring to FIG. 2, in use the builder first enters building plan information including any of desired on-center construction distances and opening locations into the control subsystem 30. Next the builder indexes plate marker system 20 to a plate by aligning the start indicator line 28 on frame 24 with the end-edge of a plate and then presses a start button in the control subsystem 30. Finally to commence marking the builder uses handle 22 to guide plate marker system 20 along the plate, ensuring the wheel is always in rolling contact with the plate surface. It should be understood that control subsystem 30 has the wheel 26 circumference and the distance between frame start indicator line 28 and the contact point of wheel and the plate (distance 44) dimensions stored in memory. Those skilled in the art will understand that control subsystem 30 will operate to measure distances from the end-edge of the plate, to determine the desired mark locations for any one of a member, a stud, a specialized stud, and to place a plurality of marks on a plate at the desired mark location(s).

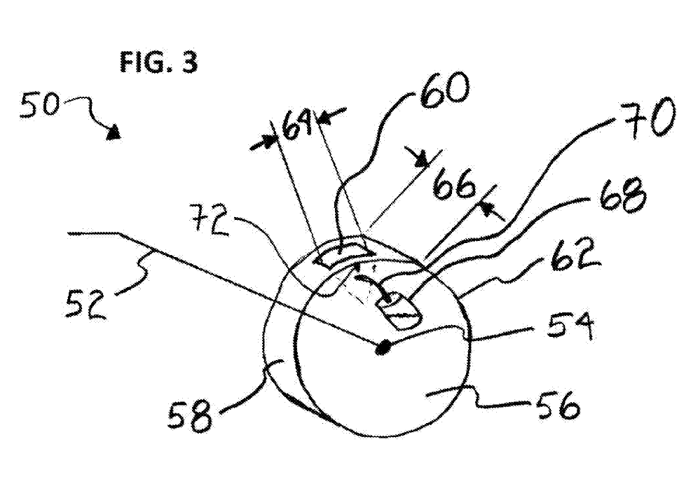

Referring to FIG. 3 an isometric view of wheel marking system 50 having a handle 52 coupled to wheel 56 at a hub 54. Wheel 56 has a rolling surface 58 that contacts a plate not shown in FIG. 3. The wheel 56 also has a pocket interior of the surface 58 to hold ink pad 60. The ink pad 60 extends radially just beyond radius of wheel 56 to functionally allow wetted marking ink to transfer from ink pad 60 to a plate surface as wheel 56 surface 58 rolls along a plate. A compression spring or load source (also not shown in FIG. 3) may reside inside pocket of wheel 56 surface 58 and apply radial force to ink pad 60 to improve transfer of marking ink from pad 60 to plate.

Wheel 56 has a circumference dimension 62, an ink pad marking dimension 64 and a wheel width dimension 66. While not limiting, the nominal dimension of ink pad 60 marking dimension 64 is 1½ inches. Also while not limiting, the nominal circumference dimension 62 of wheel 56 is at least one of 12, 16, 24 and 23.62 inches. For wheel 56 index purposes, wheel 56 also has wheel start indicator line 72 located near its outer circumference. Line 72 is further located in the middle of ink pad 60 (also the middle of ink pad marking dimension 64).

Optionally a container of marking fluid 68 is attached to wheel 56 and coupled to pad 60 through sidewall of wheel 56 by an ink transport tube 70. While a load source such a compressed air applied to container 68 may be used to aid transfer of marking fluid to pad 60 through hose 70, preferably gravity forces provide sufficient load source to move marking fluid from container 68 to pad 60 when wheel 56 rotates to position pad 60 below container 68. Handle 52 may be attached to hub 54 on either side of wheel to avoid rolling interference with container 68 and tube 70.

Still referring to FIG. 3, in use the builder first indexes the wheel marking system 50 by aligning index line 72 with end-edge of a plate. Next while applying any necessary pressure or force to handle 52 to maintain continuous rolling contact of surface 58 with plate, the builder rolls wheel 56 along a plate to produce equivalent marks on plate as previously described in disclosed main embodiment marking tape. The builder's applied force to handle 52 helps prevent wheel surface 58 from skidding or sliding on the plate and depresses ink pad 60 into pocket (or otherwise overcomes optional radially applied load source against pad 60) when pad 60 passes over plate to transfer marking fluid from pad 60 to plate surface.

Given the teachings in FIG. 3, those skilled in the art will recognize that wheel 56 circumference dimension 62 can be multiples of the above indicated nominal center distances to produce a larger wheel 56 in wheel marking system 50. As an example to produce 16 inch center marks, if wheel 56 circumference dimension 62 were 16 inches a functionally equivalent wheel 56 may have dimension 62 of 32 inches and also have two opposing ink pads 60 both located 180 degrees from each other on wheel 56. In this example pads 60 may be refreshed from the same container of marking fluid 68.

A person having ordinary skill in the art would understand that the invention has applications in framing buildings. This invention could be incorporated into other machines without limitation.

Many variations of the invention will occur to those skilled in the art. Some variations include marks only on a first side of the tape, other variations include marks on both a first and a second side of the tape. Other variations of marks on tape are allowed without limit. All such variations are intended to be within the scope and spirit of the invention.

Although some embodiments are shown to include certain features, the applicant specifically contemplates that any feature disclosed herein may be used together or in combination with any other feature on any embodiment of the invention. It is also contemplated that any feature may be specifically excluded from any embodiment of the invention.

What is claimed is:

1. A length of marking tape having a plurality of marks, wherein at least one of the marks is indexed to an end-edge of a plate before affixing the tape to the plate, the tape comprising a first side comprising a plurality of marks operative to substantially indicate the desired attachment locations of a plurality of members to a plate.

2. The system of claim 1 further comprising:
printed construction information on the tape that is operative to display to the builder at least one of the following;
a locating mark operative to correctly index the tape on the plate, said locate mark positions said marks printed on said tape to coincide with desired member attachment locations on plate;
a member name or symbol;
a member length, said member to be attached to said plate.

3. The system of claim 1 further comprising of marks printed on tape that is to be attached to a plate, said marks further comprising:
a first series of uniformly spaced group of said marks substantially representative of a 12 inch on-center location; or
a second series of uniformly spaced group of said marks substantially representative of a 16 inch on-center location; or
a third series of uniformly spaced group of said marks substantially representative of a 24 inch on-center location; or
a fourth series group of said marks, substantially representative of any combination of said marks in said first, second or third series; or
a fifth series group of said marks, substantially representative of at least one of a 12, 16 or 24 inch on-center locations; or
a sixth series of said marks, each said mark substantially representative of a desired attachment location of a said member to a said plate; or
a seventh series of said marks, each said mark substantially representative of a desired attachment location of a said member to a said plate; or
an eight series group of said marks, substantially representative of at least one of a 12, 16 or 24 inch on-center locations.

4. The tape of claim 1, further comprising:
a plurality of said marks on printed on at least one of a first side and a second side of said tape.

5. The tape of claim 1, further comprising:
a second side, opposite to said plurality of said marks on said first side, that is adhesive to affix said tape to said plate.

6. The tape of claim 1, further comprising:
a material that substantially resists tearing deformation when attached to a plate using a plurality of staples.

7. A tape marking system for printing a plurality of marks on a role of tape such that each mark is substantially representative of a framing member attachment location, the system comprising:
a computer to operate a computer software and a printer;
a length of tape that said printer prints marks on;
said computer software being operative to
receive building plans, said plans comprised of at least one of framing on-center member information and opening member information;
from the building plans, determine marks to be printed on said tape;
control said printer to print said plurality of marks on said tape; and
wherein said printed marks indicate substantially desired attachment locations of a plurality of members to be affixed to a plate.

8. The system of claim 7 further comprising:
printed construction information on the tape that is operative to display to the builder at least one of the following;
a locating mark operative to correctly index the tape on the plate, said locate mark positions said marks printed on said tape to coincide with desired member attachment locations on plate;
a member name or symbol;
a member length, said member to be attached to said plate.

9. The system of claim 7 further comprising of marks printed on tape that is to be attached to a plate, said marks further comprising:
a first series of uniformly spaced group of said marks substantially representative of a 12 inch on-center location; or
a second series of uniformly spaced group of said marks substantially representative of a 16 inch on-center location; or
a third series of uniformly spaced group of said marks substantially representative of a 24 inch on-center location; or
a fourth series group of said marks, substantially representative of any combination of said marks in said first, second or third series; or
a fifth series group of said marks, substantially representative of at least one of a 12, 16 or 24 inch on-center locations; or
a sixth series of said marks, each said mark substantially representative of a desired attachment location of a said member to a said plate; or
a seventh series of said marks, each said mark substantially representative of a desired attachment location of a said member to a said plate; or
an eight series group of said marks, substantially representative of at least one of a 12, 16 or 24 inch on-center locations.

10. The tape of claim 7, further comprising:
a plurality of said marks on printed on at least one of a first side and a second side of said tape.

11. The tape of claim 7, further comprising:
a second side, opposite to said plurality of said marks on said first side, that is adhesive to affix said tape to said plate.

12. The tape of claim 7, further comprising:
a material that substantially resists tearing deformation when attached to a plate using a plurality of staples.
